(19) United States
(12) Patent Application Publication
(10) Pub. No.: US 2014/0225321 A1
(43) Pub. Date: Aug. 14, 2014

(54) SUBSTRATE TRANSFER APPARATUS

(71) Applicant: Samsung Display Co., Ltd., Yongin-City (KR)

(72) Inventor: Jin Ok Roh, Cheonan-si (KR)

(73) Assignee: Samsung Display Co., Ltd., Yongin-City (KR)

(21) Appl. No.: 13/972,878

(22) Filed: Aug. 21, 2013

(30) Foreign Application Priority Data
Feb. 12, 2013 (KR) 10-2013-0014963

(51) Int. Cl. B23Q 3/00

(52) U.S. Cl. CPC B23Q 3/00
USPC 269/37

(57) ABSTRACT

A substrate transfer apparatus includes a substrate carrier including a plurality of grooves configured to receive substrates, a frame on the substrate carrier and including a plurality of open areas respectively corresponding to the grooves, a plurality of mask holders each at a corresponding one of the open areas and configured to cover a corresponding one of the substrates, and a plurality of fixing members configured to couple the mask holders and the frame, wherein each of the mask holders is configured to be coupled to the frame by a corresponding number of the fixing members, and wherein at least a portion of the fixing members is formed of an austenitic stainless steel.

### CROSS-REFERENCE TO RELATED APPLICATION

This application claims priority under 35 U.S.C. §119 to and the benefit of Korean Patent Application No. 10-2013-0014963, filed on Feb. 12, 2013, the contents of which are hereby incorporated by reference in its entirety.

### BACKGROUND

1. Field

The present disclosure relates to a substrate transfer apparatus.

2. Description of the Related Art

In recent years, various flat panel display devices, such as liquid crystal display devices, organic light emitting display devices, electrowetting display devices, electrophoretic display devices, etc., have been developed.

A sputtering process is used to form layers of the flat panel display device. For instance, various layers, e.g., a metal layer, a transparent conductive layer, a dielectric layer, etc., are formed on a substrate using the sputtering process. The sputtering process is performed in a sputtering apparatus, and the substrate is transferred into the sputtering apparatus to perform the sputtering process on the substrate. The substrate is transferred to the sputtering apparatus by a substrate transfer apparatus.

The substrate is loaded on the substrate transfer apparatus and inclined at a predetermined angle. In this case, in order to prevent the substrate from being separated from the substrate transfer apparatus when the substrate transfer apparatus moves, a mask holder is used to cover the substrate.

### SUMMARY

Embodiments of the present invention provide a substrate transfer apparatus capable of preventing (or reducing the possibility of) generation of a foreign substance at a fixing member used to fix a mask holder to a frame.

Embodiments of the present invention provide a substrate transfer apparatus including a substrate carrier including a plurality of grooves configured to receive substrates, a frame on the substrate carrier and including a plurality of open areas respectively corresponding to the grooves, a plurality of mask holders each at a corresponding one of the open areas and configured to cover a corresponding one of the substrates, and a plurality of fixing members configured to couple the mask holders and the frame, wherein each of the mask holders is configured to be coupled to the frame by a corresponding number of the fixing members, and wherein at least a portion of the fixing members is formed of an austenitic stainless steel.

Each of the fixing members may include a body extending in a row direction, a first connection portion coupled to a left side surface of the body, a second connection portion coupled to a right side surface of the body, a connection pin in the body, a connection pin transfer part on the body and coupled to the connection pin, and an elastic member in the body and at a first side of the connection pin, wherein the first and second connection portions are coupled to a corresponding one of the mask holders, and wherein a second side of the connection pin is configured to be coupled to the frame.

The body, the first and second connection portions, the connection pin, and the connection pin transfer part may be formed of the austenitic stainless steel.

The body may include a first body extending in the row direction, a second body coupled to the first body, a first hole in the first body, and a second hole at an upper portion of the first body and coupled to the first hole, wherein an upper surface of the first body and an upper surface of the second body have a same height, a first thickness between the upper and lower surfaces of the first body is greater than a second thickness between the upper and lower surfaces of the second body, a front surface of the first body is substantially perpendicular to the lower surface of the second body, and a first length between the front and rear surfaces of the first body is longer than a second length between the front and rear surfaces of the second body.

The first hole may extend in the row direction and may be formed in the first body, a first side of the first hole may abut a rear portion of the first body to form an inner rear surface facing the rear surface of the first body, a second side of the first hole may be formed through a portion of the front surface of the first body, and the elastic member and a portion of the connection pin may be in the first hole.

A first side of the elastic member may be at the inner rear surface of the first body, the first side of the connection pin may be in the first hole and adjacent to a second side of the elastic member, and the second side of the connection pin may be exposed outside of the first hole.

The connection pin may include a first column portion exposed outside of the first hole and configured to be coupled to the frame, a second column portion in the first hole, and a third column portion exposed outside of the first hole to connect a first side of the first column portion and a second side of the second column portion, and a first side of the second column portion is at the second side of the elastic member, wherein the first column portion has a diameter smaller than a diameter of the second column portion

The substrate transfer apparatus may further include a plurality of connection holes in an inner side surface of the frame, which is formed by the open areas, wherein the front surface of the first body faces the inner side surface of the frame, the lower surface of the second body contacts an upper surface of the frame, and the first column portion is configured to be inserted into a corresponding one of the connection holes.

The second hole may be through an area of the upper surface of the first body and may be coupled to the first hole, the second hole may be defined by a length in the row direction and a width in a column direction crossing the row direction, and the connection pin transfer part may be in the second hole.

An area of the connection pin may be exposed through the second hole and the elastic member may not be exposed through the second hole.

The connection pin and the connection pin transfer part may be configured to move back and forth along the length of the second hole by an elasticity of the elastic member and an external force, wherein a range in which the connection pin transfer part moves along the length is defined by the second hole.

A lower surface of the body, a lower surface of the first connection portion, and a lower surface of the second connection portion may be on an upper surface of a corresponding one of the mask holders.

The substrate transfer apparatus may further include a plurality of engaging members, wherein the first connection portion includes a third hole and a fourth hole, the second connection portion includes a fifth hole and a sixth hole, each of the mask holders includes a plurality of engaging holes corresponding to the third, fourth, fifth, and sixth holes, and the engaging members are respectively inserted into the engaging holes after passing through the third to sixth holes to couple the first and second connection portions to each of the mask holders.

The substrate transfer apparatus may further include a transfer part including a plurality of transfer wheels, wherein the transfer wheels are under the transfer part, and the substrate carrier is on the transfer part.

The mask holders may include a same size and shape as those of the grooves.

According to the above, the substrate transfer apparatus may prevent (or reduce the possibility of) generation of the foreign substance at the fixing member used to fix the mask holder to the frame.

### BRIEF DESCRIPTION OF THE DRAWINGS

The above and other aspects of the present invention will become readily apparent by reference to the following detailed description when considered in conjunction with the accompanying drawings wherein:

FIG. 1 is a perspective view showing a substrate transfer apparatus according to an exemplary embodiment of the present invention;

FIG. 2 is a perspective view showing the substrate carrying part shown in FIG. 1;

FIG. 3 is a side view showing the substrate transfer apparatus shown in

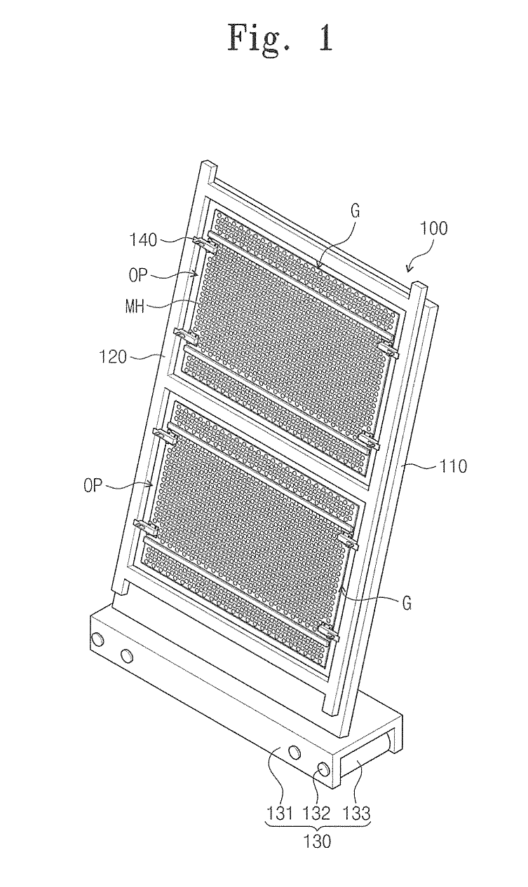

FIG. 1;

FIG. 4 is a perspective view showing the fixing member shown in FIG. 1;

FIG. 5 is a side view showing the fixing member shown in FIG. 1;

FIG. 6 is a cross-sectional view taken along a line I-I′ shown in FIG. 4;

FIG. 7 is a plan view showing the fixing member shown in FIG. 1;

FIGS. 8A to 8C are views showing the mask holder and the frame shown in FIG. 1, which are fixed by a fixing member; and

FIG. 8D is a cross-sectional view taken along a line II-II′ shown in FIG. 8C.

### DETAILED DESCRIPTION

It will be understood that when an element or layer is referred to as being “on”, “connected to” or “coupled to” another element or layer, it can be directly on, connected or coupled to the other element or layer, or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of embodiments of the present invention.

Spatially relative terms, such as “beneath”, “below”, “lower”, “above”, “upper” and the like, may be used herein for ease of description to describe the relationship of one element or feature to another (or other) element(s) or feature(s), as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations), and the spatially relative descriptors used herein interpreted accordingly.

The terminology used herein is for the purpose of describing particular embodiments only and is not intended to be limiting of the invention. As used herein, the singular forms, “a”, “an” and “the” are intended to include the plural forms as well, unless the context clearly indicates otherwise. It will be further understood that the terms “includes” and/or “including”, when used in this specification, specify the presence of stated features, integers, steps, operations, elements, components and/or groups, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, embodiments of the present invention will be explained in detail with reference to the accompanying drawings.

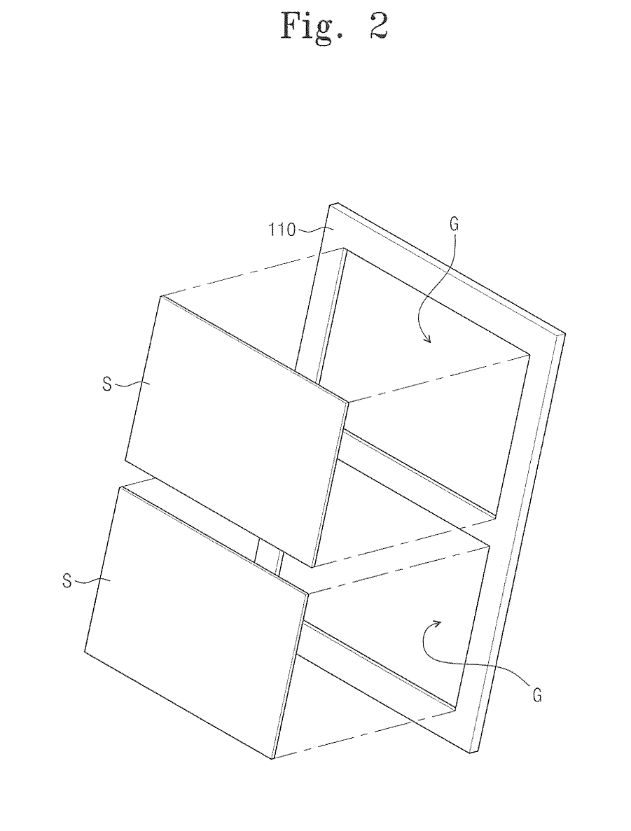

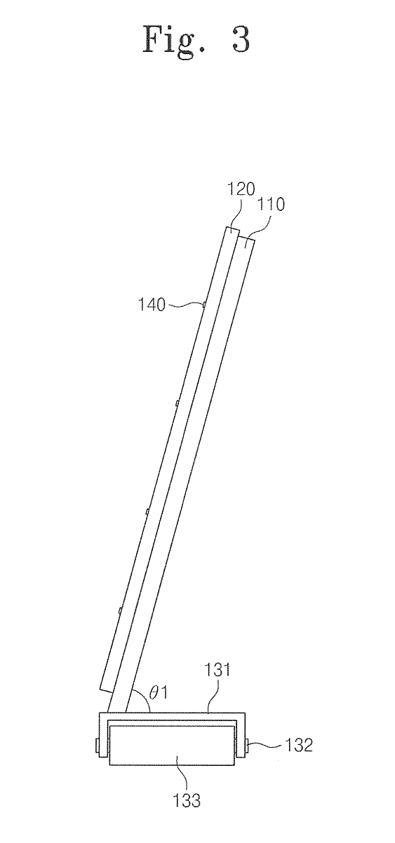

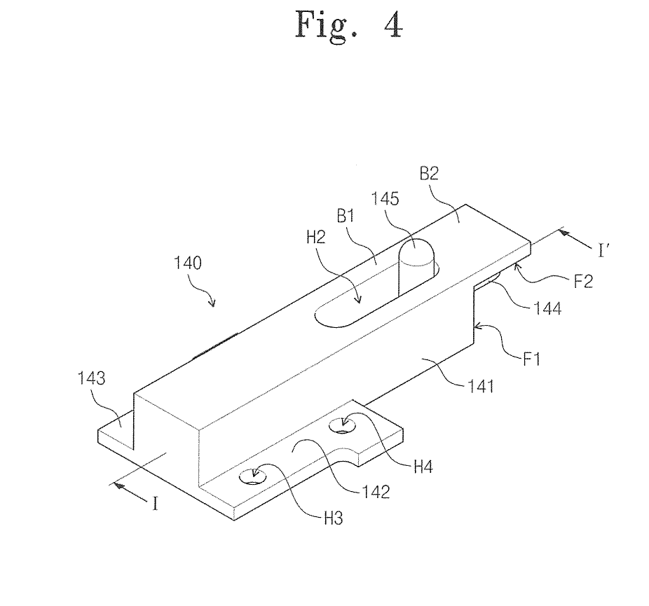

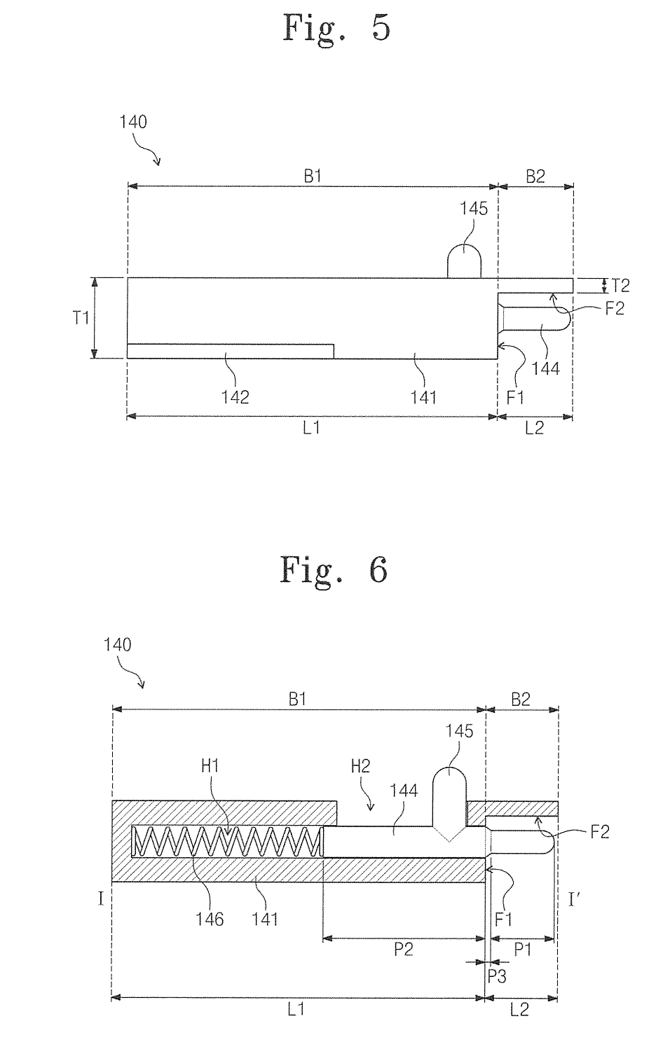

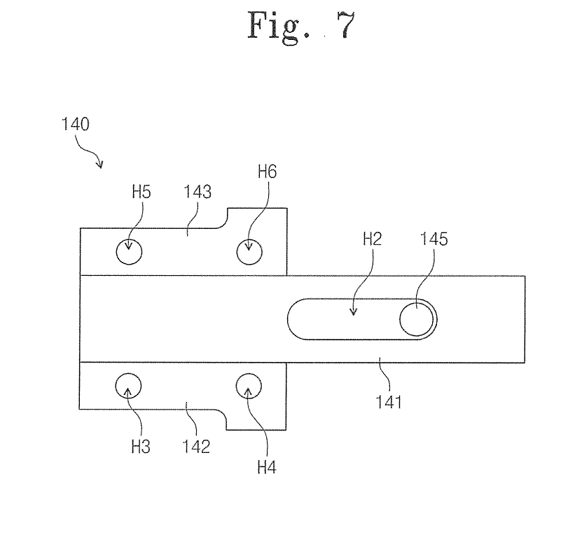

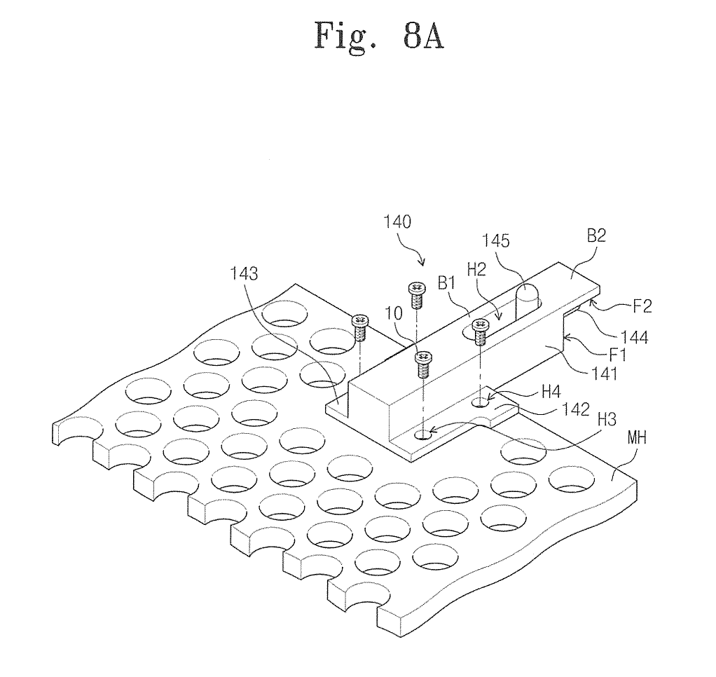

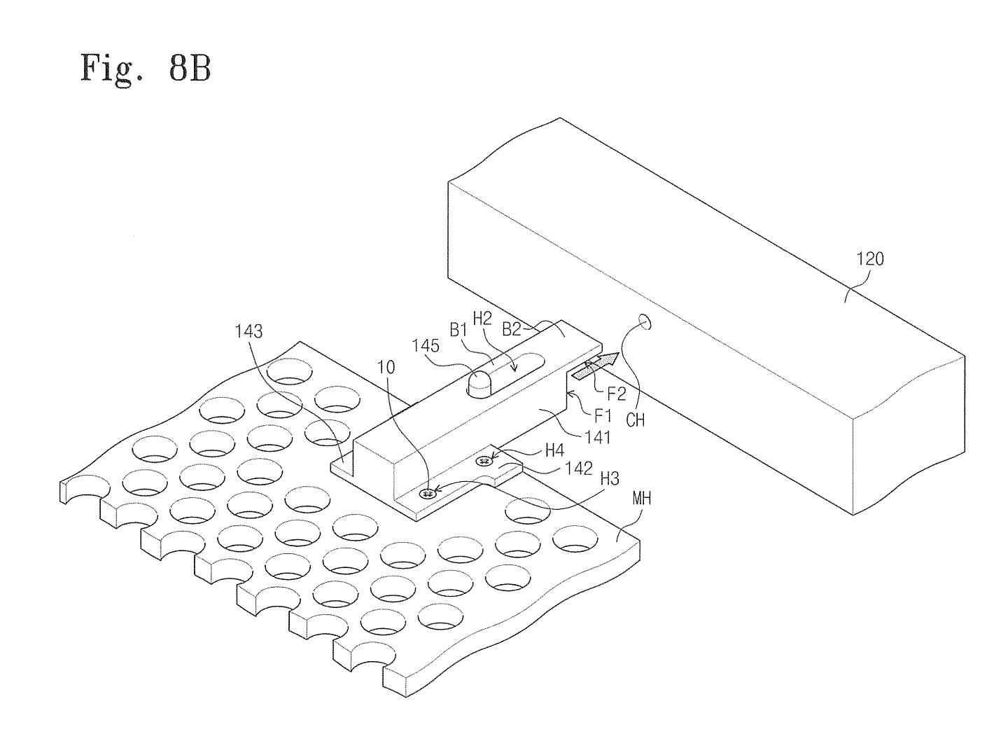

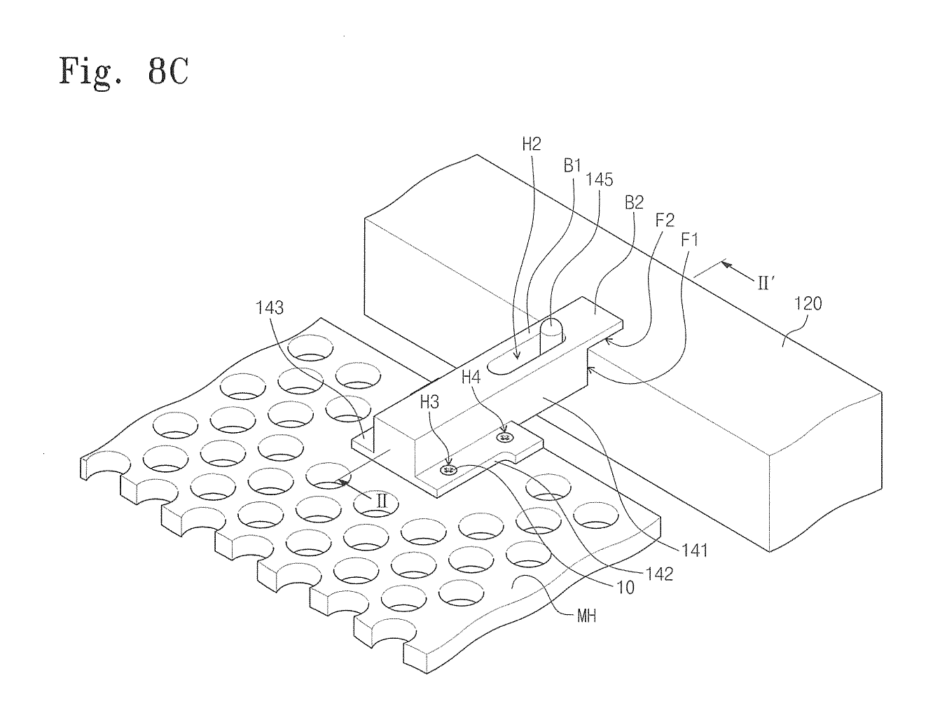

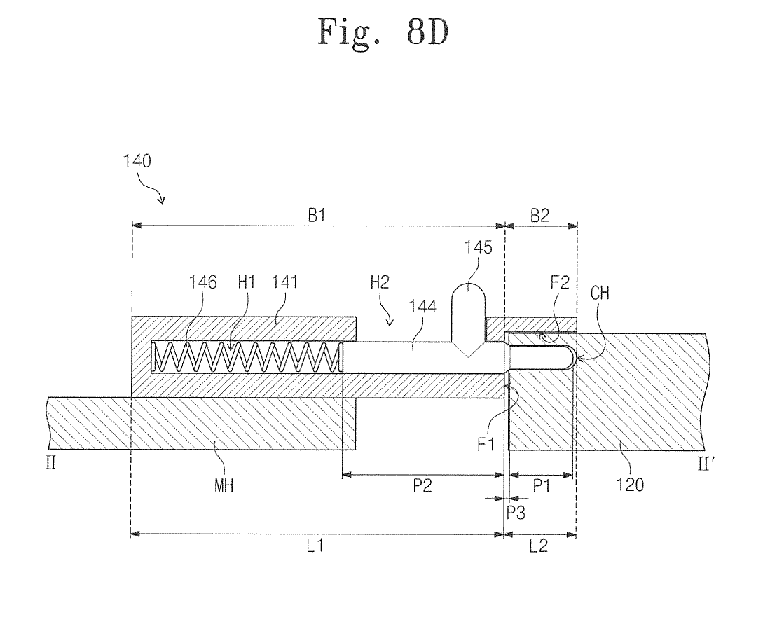

FIG. 1 is a perspective view showing a substrate transfer apparatus according to an exemplary embodiment of the present invention, FIG. 2 is a perspective view showing the substrate carrying part shown in FIG. 1, and FIG. 3 is a side view showing the substrate transfer apparatus shown in FIG. 1.

Referring to FIGS. 1, 2, and 3, a substrate transfer apparatus 100 includes a substrate carrying part (or substrate carrier) 110, a frame 120, a transfer part 130, a plurality of mask holders MH, and a plurality of fixing members 140.

The substrate carrying part 110 includes a plurality of grooves G. Substrates S are respectively placed in the grooves G of the substrate carrying part 110. In this embodiment, the substrate carrying part 110 includes two grooves G disposed (or located) at upper and lower positions, and the substrates S are placed in the two grooves G, respectively.

The frame 120 is disposed (or located) on the substrate carrying part 110. The frame 120 includes a plurality of opening areas (or open areas) OP respectively corresponding to the grooves G of the substrate carrying part 110. Each opening area OP has an area larger than that of each groove G. As an example, the frame 120 includes two opening areas OP disposed (or located) at upper and lower positions to respectively correspond to the two grooves G.

Each of the mask holders MH is disposed (or located) in a corresponding opening area OP to cover a corresponding substrate S. In this embodiment, two mask holders MH are placed in the two opening areas OP disposed (or located) at the upper and lower positions to cover the two substrates S, respectively. Because the substrates S are covered by the mask holders MH, the substrates S are not shown in FIG. 1. The mask holders MH may have the same size and shape as those of the grooves G.

The fixing members 140 connect the mask holders MH and the frame 120. For instance, the fixing members 140 may be fixed to the mask holders MH, and then coupled (or connected) to the frame 120. Accordingly, the mask holders MH are fixed to the frame 120 by the fixing members 140.

Each mask holder MH is fixed to the frame 120 by a number (e.g., a predetermined number) of the fixing members 140. In this embodiment, each mask holder MH is fixed to the frame 120 by four fixing members 140, but the number of the fixing members used to fix the mask holder may not be limited thereto or thereby. That is, each mask holder MH may be fixed to the frame 120 by four or more (or less) fixing members 140. Four fixing members 140 are disposed (or located) at left and right side portions of the corresponding mask holder MH such that two fixing members are disposed (or located) at each of the left and right side portions of the corresponding mask holder MH.

The fixing members 140 may be formed of a stainless steel, e.g., an austenitic stainless steel like SUS 304. The SUS 304 contains about 8% to about 11% nickel (Ni) and about 18% to about 20% chromium (Cr). The structure of the fixing members 140 will be described in detail with reference to FIGS. 4 to 7.

The substrate carrying part 110 on which the frame 120 is disposed (or located) is coupled to the transfer part 130. As shown in FIG. 3, the substrate carrying part 110 and the frame 120 are inclined at a first angle θ1 with respect to the transfer part 140. In the present exemplary embodiment, the first angle θ1 may be set to about 85 degrees.

The transfer part 130 includes a transfer body 131, a rotation axis 132, and a plurality of transfer wheels 133. The substrate carrying part 110 on which the frame 120 is disposed (or located) is coupled to an upper surface of the transfer body 131. The rotation axis 132 is disposed (or located) in the transfer body 131, and the transfer wheels 133 are disposed (or located) under the transfer body 131. The transfer wheels 133 rotate around the rotation axis 132 of the transfer part 130, and thus the substrate transfer apparatus 100 may move away.

The substrates S are placed in the grooves G of the substrate carrying part 110 and the mask holders MH are disposed (or located) in the opening areas OP to cover respective substrates S. In addition, the mask holders MH are fixed to the frame 120 by the fixing members 140. Thus, the substrates S placed in the grooves G of the substrate carrying part 110 may not be separated from the substrate carrying part 110 while the substrate carrying part 110 moves. The substrate transfer apparatus 100 may transfer the substrates S to a sputtering apparatus that performs a sputtering process on the substrates S.

FIG. 4 is a perspective view showing the fixing member shown in FIG. 1, FIG. 5 is a side view showing the fixing member shown in FIG. 1, FIG. 6 is a cross-sectional view taken along a line I-I′ shown in FIG. 4, and FIG. 7 is a plan view showing the fixing member shown in FIG. 1.

In the present exemplary embodiment, the fixing members 140 have the same structure and function, and thus hereinafter only one fixing member will be described in detail with reference to FIGS. 4 to 7.

Referring to FIGS. 4 to 7, the fixing member 140 includes a body 141, a first connection portion 142, a second connection portion 143, a connection pin 144, a connection pin transfer part 145, and an elastic member 146.

The body 141 extends in a row direction. The first and second connection portions 142 and 143 are coupled to left and right side surfaces of the body 141. The connection pin 144 is disposed (or located) inside the body 141, and the connection pin transfer part 145 is disposed (or located) on the body 141 to be coupled to the connection pin 144. The elastic member 146 is disposed (or located) inside the body 141 to be disposed (or located) adjacent to one side of the connection pin 144. The first and second portions 142 and 143 are coupled to the corresponding mask holder MH, and the other one side of the connection pin 144 is coupled to the frame 120.

The body 141 includes a first body B1 extending in the row direction, a second body B2 coupled to the first body B1, and first and second holes H1 and H2 formed through the first body B1. An upper surface of the first body B1 and an upper surface of the second body B2 have the same height. A first thickness T1 between the upper and lower surfaces of the first body B1 is greater than a second thickness T2 between the upper and lower surfaces of the second body B2. A front surface F1 of the first body B1 is substantially vertical (or perpendicular) to the lower surface F2 of the second body B2. A first length L1 between the front surface F1 and a rear surface of the first body B1 is longer than a second length L2 between front and rear surfaces of the second body B2.

The first hole H1 extends in the row direction and is formed in the first body B1. One end portion of the first hole H1 is blocked by a rear portion of the first body B1 to provide an inner rear surface of the first body B1, which faces the rear surface of the first body B1. The other one end of the first hole H1 is formed through (or to open) a portion (e.g., a predetermined portion) of the front surface F1 of the first body B1.

The lower surface of the body 141, the lower surface of the first connection portion 142, and the lower surface of the second connection portion 143 have the same height. The lower surface of the body 141, the lower surface of the first connection portion 142, and the lower surface of the second connection portion 143 make contact with the upper surface of the mask holder MH.

The elastic member 146 and a portion of the connection pin 144 are located (or accommodated) in the first hole H1. In detail, one side of the elastic member 146 is located (or disposed) at the inner rear surface of the first body B1 One side of the connection pin 144 is located (or accommodated) in the first hole H1 to be disposed (or located) adjacent to the other one side of the elastic member 146. The other one side of the connection pin 144 is disposed (or located) to be exposed to the outside.

The connection pin 144 includes a first column portion P1, a second column portion P2, and a third column portion P3. The first column portion P1 is exposed to the outside of the first hole H1. The second column portion P2 is located (or accommodated) in the first hole H1. One side of the second column portion P2 is disposed (or located) adjacent to the other one side of the elastic member 146. The first column portion P1 has a diameter that is smaller than a diameter of the second column portion P2. The first column portion P1 has a length that is shorter than the first length L1 of the first body B1.

The third column portion P3 is exposed to the outside of the first hole H1 to connect the one side of the first column portion P1 and the other one side of the second column portion P2. The first column portion P1 is coupled to the frame 120. The connection structure between the first column portion P1 and the frame 120 will be described in detail with reference to FIGS. 8A to 8D.

The second hole H2 is formed through (or to open) an area (e.g., a predetermined area) of the upper surface of the first body B1. The second hole H2 is defined by a long side (e.g., length) in the row direction and a short side (e.g., width) in a column direction crossing the row direction, when viewed in a top view. The second hole H2 is coupled to the first hole H1.

The connection pin transfer part 145 is disposed (or located) at the second hole H2. The connection pin transfer part 145 is coupled to the connection pin 144. The connection pin 144 is partially exposed through the second hole H2. In detail, the connection pin transfer part 145 is coupled to the second column portion P2 of the connection pin 144, and a portion (e.g., a predetermined portion) of the second column portion P2 of the connection pin 144 is exposed through the second hole H2. The elastic member 146 is not exposed through the second hole H2.

In a case that an external force is not applied, the connection pin transfer part 145 coupled to the connection pin 144 moves in a forward direction, i.e., a direction from the rear surface of the first body B1 toward the front surface F1 of the second body B2, by a force exerted on the connection pin 144 by the elastic member 146. The connection pin transfer part 145, moved in the forward direction, of the second body B2, may be disposed (or located) at a right edge of the long side of the second hole H2.

The connection pin transfer part 145 may move in a direction pointing from the front surface of the second body B2 toward the rear surface of the second body B2 through (or along) the second hole H2 by the external force applied thereto. The connection pin transfer part 145 moved in the direction pointing from the front surface of the second body B2 toward the rear surface of the second body B2 may be disposed (or located) at a left edge of the long side of the second hole H2. According to the movement of the connection pin transfer part 145, the connection pin 144 coupled to the connection pin transfer part 145 may move in the direction pointing from the front surface of the second body B2 toward the rear surface of the second body B2.

When the external force is stopped, the connection pin 144 moves again in the forward direction by an elasticity of the elastic member 146. In addition, the connection pin transfer part 145 coupled to the connection pin 144 moves in the forward direction. Accordingly, the connection pin 144 and the connection pin transfer part 145 coupled to the connection pin 144 moves back and forth along the long side direction of the second hole H2 by the elasticity of the elastic member 146 and the external force. Further, a range, in which the connection pin transfer part 145 moves, is determined by the length of the long side of the second hole H2.

The first and second connection portions 142 and 143 are coupled to the left and right side surfaces of the body 141. The first connection portion 142 includes a third hole H3 and a fourth hole H4. The second connection portion 143 includes a fifth hole H5 and a sixth hole H6. The fixing member 140 is coupled to the corresponding mask holder MH by the first and second connection portions 142 and 143. This structure will be described in detail below.

When the body 141 of the fixing member 140 is formed of aluminum and the connection pin 144 and the connection pin transfer part 145 are formed of stainless steel, a friction may occur between a boundary surface of the first hole H1 of the body 141 and the connection pin 144 and between a boundary surface of the second hole H2 of the body 141 and the connection pin transfer part 145 while the connection pin 144 and the connection pin transfer part 145 move. In this case, due to a grinding phenomenon caused by a strength difference between the body 141 formed of aluminum and the connection pin 144 formed of stainless steel and between the body 141 formed of aluminum and the connection pin transfer part 145 formed of stainless steel, generation of a foreign substance may occur. The foreign substance may be stacked in the first hole H1, so that the connection pin 144 and the connection pin transfer part 145 may be abnormally operated. In addition, a cleaning process may remove the foreign substance stacked in the first hole H1 after the fixing member 140 is separated.

In the present exemplary embodiment, however, the body 141 of the fixing member 140, the connection pin 144, and the connection pin transfer part 145 may be formed of stainless steel. As an example, the body 141 of the fixing member 140, the connection pin 144, and the connection pin transfer part 145 may be formed of the austenitic stainless steel, like SUS 304. In addition, the first and second connection portions 142 and 143 may be formed of the austenitic stainless steel.

The body 141 of the fixing member 140, the connection pin 144, and the connection pin transfer part 145, which may be formed of the stainless steel, have the same strength. Because the body 141, the connection pin 144, and the connection pin transfer part 145 may have the same strength, the possibility of the grinding phenomenon, which is caused by the strength difference between the body 141, the connection pin 144, and the connection pin transfer part 145, may be reduced (or prevented), thereby reducing (or preventing) the possibility of the foreign substance being generated.

Consequently, the substrate transfer apparatus 100 may reduce (or prevent) the possibility of the foreign substance from being generated in the fixing member 140 used to fix the mask holder MH to the frame 120.

FIGS. 8A to 8C are views showing the mask holder and the frame shown in FIG. 1, which are fixed by the fixing member, and FIG. 8D is a cross-sectional view taken along a line II-II′ shown in FIG. 8C.

Referring to FIG. 8A, the fixing member 140 is coupled to the mask holder MH. In detail, the lower surface of the body 141 of the fixing member 140, the lower surface of the first connection portion 142, and the lower portion of the second connection portion 143 are disposed (or located) on the upper surface of the corresponding mask holder MH. The first and second connection portions 142 and 143 are disposed (or located) to allow a front boundary thereof to match with a boundary of the mask holder MH.

Engaging members 10, e.g., bolts, are disposed (or located) in the third and fourth holes H3 and H4 of the first connection portion 142 and the fifth and sixth holes H5 and H6 of the second connection portion 143, respectively. Although not shown in figures, the mask holder MH includes engaging holes respectively corresponding to the third, fourth, fifth, and sixth holes H3, H4, H5, and H6. The engaging members 10 are respectively inserted into the engaging holes after passing through the third to sixth holes H3 to H6, and thus the mask holder MH is fixed to the first and second connection portions 142 and 143. As described above, the fixing member 140 is coupled to the mask holder MH by the first and second connection portions 142 and 143.

Referring to FIG. 8B, the connection pin transfer part 145 of the fixing member 140 fixed to the mask holder MH moves in the rearward direction of the first body B1 by the external force. In addition, the connection pin 144 coupled to the connection pin transfer part 145 moves in the rearward direction in the first hole H1. The fixing member 140 moves toward the frame 120.

Referring to FIGS. 8C and 8D, the front surface F1 of the first body B1 of the fixing member 140 is disposed (or located) to face an inner side surface of the frame 120, and the lower surface F2 of the second body B2 of the fixing member 140 makes contact with the upper surface of the frame 120. When the external force is stopped, the connection pin transfer part 145 of the fixing member 140 moves in the forward direction by the elasticity of the elastic member 146.

The frame 120 includes a plurality of connection holes CH respectively corresponding to the fixing members 140. The connection holes CH are formed in the inner side surface of the frame 120, which is formed by the opening areas OP of the frame 120. For the convenience of explanation, only one connection hole CH has been shown in FIGS. 8B and 8D, but the number of the connection holes CH corresponds to the number of the fixing members 140, and thus the connection holes CH are disposed (or located) to correspond to the fixing members 140.

The connection pins 144 of the fixing members 140 are inserted into the connection holes CH of the frame 120. In detail, the connection pin 144 coupled to the connection pin transfer part 145 is inserted into a corresponding connection hole CH of the connection holes CH as shown in FIG. 8D. That is, the first column portion P1 of the connection pin 144 is inserted into the corresponding connection hole CH.

Due to the above-mentioned structure, the mask holders MH are fixed to the frame 120 by the fixing members 140 while the mask holders MH cover the substrates S.

In the present exemplary embodiment, the body 141 of the fixing member 140, the first and second connection portions 142 and 143, the connection pin 144, and the connection pin transfer part 145 are formed of the stainless steel. The body 141 of the fixing member 140, the first and second connection portions 142 and 143, the connection pin 144, and the connection pin transfer part 145, which are formed of the stainless steel, have the same strength. Because the body 141, the connection pin 144, and the connection pin transfer part 145 have the same strength, the possibility of the grinding phenomenon occurring, which is caused by the strength difference between the body 141, the connection pin 144, and the connection pin transfer part 145, may be reduced (or prevented), thereby reducing (or preventing) the possibility of the foreign substance being generated.

Consequently, the substrate transfer apparatus 100 may reduce (or prevent) the possibility of a foreign substance being generated in the fixing member 140 used to fix the mask holder MH to the frame 120.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed, and equivalents thereof.

What is claimed is:

1. A substrate transfer apparatus comprising:
a substrate carrier comprising a plurality of grooves configured to receive substrates;
a frame on the substrate carrier and comprising a plurality of open areas respectively corresponding to the grooves;
a plurality of mask holders each at a corresponding one of the open areas and configured to cover a corresponding one of the substrates; and
a plurality of fixing members configured to couple the mask holders and the frame, wherein each of the mask holders is configured to be coupled to the frame by a corresponding number of the fixing members, and wherein at least a portion of the fixing members is formed of an austenitic stainless steel.

2. The substrate transfer apparatus of claim 1, wherein each of the fixing members comprises:
a body extending in a row direction;
a first connection portion coupled to a left side surface of the body;
a second connection portion coupled to a right side surface of the body;
a connection pin in the body;
a connection pin transfer part on the body and coupled to the connection pin; and
an elastic member in the body and at a first side of the connection pin, wherein the first and second connection portions are coupled to a corresponding one of the mask holders, and wherein a second side of the connection pin is configured to be coupled to the frame.

3. The substrate transfer apparatus of claim 2, wherein the body, the first and second connection portions, the connection pin, and the connection pin transfer part are formed of the austenitic stainless steel.

4. The substrate transfer apparatus of claim 2, wherein the body comprises:
a first body extending in the row direction;
a second body coupled to the first body;
a first hole in the first body; and
a second hole at an upper portion of the first body and coupled to the first hole, wherein an upper surface of the first body and an upper surface of the second body have a same height, a first thickness between the upper and lower surfaces of the first body is greater than a second thickness between the upper and lower surfaces of the second body, a front surface of the first body is substantially perpendicular to the lower surface of the second body, and a first length between the front and rear surfaces of the first body is longer than a second length between the front and rear surfaces of the second body.

5. The substrate transfer apparatus of claim 4, wherein the first hole extends in the row direction and is formed in the first body, a first side of the first hole abuts a rear portion of the first body to form an inner rear surface facing the rear surface of the first body, a second side of the first hole is formed through a portion of the front surface of the first body, and the elastic member and a portion of the connection pin are in the first hole.

6. The substrate transfer apparatus of claim 5, wherein a first side of the elastic member is at the inner rear surface of the first body, the first side of the connection pin is in the first hole and adjacent to a second side of the elastic member, and the second side of the connection pin is exposed outside of the first hole.

7. The substrate transfer apparatus of claim 6, wherein the connection pin comprises:
a first column portion exposed outside of the first hole and configured to be coupled to the frame;
a second column portion in the first hole; and
a third column portion exposed outside of the first hole to connect a first side of the first column portion and a second side of the second column portion, and a first side of the second column portion is at the second side of the elastic member, wherein the first column portion has a diameter smaller than a diameter of the second column portion.

8. The substrate transfer apparatus of claim 7, further comprising a plurality of connection holes in an inner side surface of the frame, which is formed by the open areas, wherein the front surface of the first body faces the inner side surface of the frame, the lower surface of the second body contacts an upper surface of the frame, and the first column portion is configured to be inserted into a corresponding one of the connection holes.

9. The substrate transfer apparatus of claim 4, wherein the second hole is through an area of the upper surface of the first body and is coupled to the first hole, the second hole is defined by a length in the row direction and a width in a column direction crossing the row direction, and the connection pin transfer part is in the second hole.

10. The substrate transfer apparatus of claim 9, wherein an area of the connection pin is exposed through the second hole and the elastic member is not exposed through the second hole.

11. The substrate transfer apparatus of claim 9, wherein the connection pin and the connection pin transfer part are configured to move back and forth along the length of the second hole by an elasticity of the elastic member and an external force, wherein a range in which the connection pin transfer part moves along the length is defined by the second hole.

12. The substrate transfer apparatus of claim 2, wherein a lower surface of the body, a lower surface of the first connection portion, and a lower surface of the second connection portion are on an upper surface of a corresponding one of the mask holders.

13. The substrate transfer apparatus of claim 12, further comprising a plurality of engaging members, wherein the first connection portion comprises a third hole and a fourth hole, the second connection portion comprises a fifth hole and a sixth hole, each of the mask holders comprises a plurality of engaging holes corresponding to the third, fourth, fifth, and sixth holes, and the engaging members are respectively inserted into the engaging holes after passing through the third to sixth holes to couple the first and second connection portions to each of the mask holders.

14. The substrate transfer apparatus of claim 1, further comprising a transfer part comprising a plurality of transfer wheels, wherein the transfer wheels are under the transfer part, and the substrate carrier is on the transfer part.

15. The substrate transfer apparatus of claim 1, wherein the mask holders comprise a same size and shape as those of the grooves.
